(19) United States
(12) Patent Application Publication
(10) Pub. No.: US 2017/0118974 A1
(43) Pub. Date: May 4, 2017

(54) Sticky back rodent bait tab

(71) Applicant: David Ray Johnson, Blackfoot, ID (US)

(72) Inventor: David Ray Johnson, Blackfoot, ID (US)

(21) Appl. No.: 14/932,648

(22) Filed: Nov. 4, 2015

(51) Int. Cl. A01M 23/00

(52) U.S. Cl. CPC A01M 23/005

(57) ABSTRACT

The sticky back rodent bait tab attracts baits and affixes On live and or rat mouse snap traps

FIG. 1 Chip board base of said tab predetermined shapes and or sizes such as square, Rectangle, round and oval.

FIG. 2 Molasses, said molasses applied to chip board.

FIG. 3 Beeswax applied to said molasses, dried fruits and or vegetables All on front said chip board.

FIG. 4 Apply adhesive and or two sided tape with release paper on the back side.

FIG. 5 Dried fruits and or vegetables applied to said molasses.

### DRAWINGS LIST

FIG. 1 Chip board.

FIG. 2 Molasses.

FIG. 3 Beeswax.

FIG. 4 Adhesive and or two sided poly tape with release paper.

FIG. 5 Dried fruit and or dried vegetables.

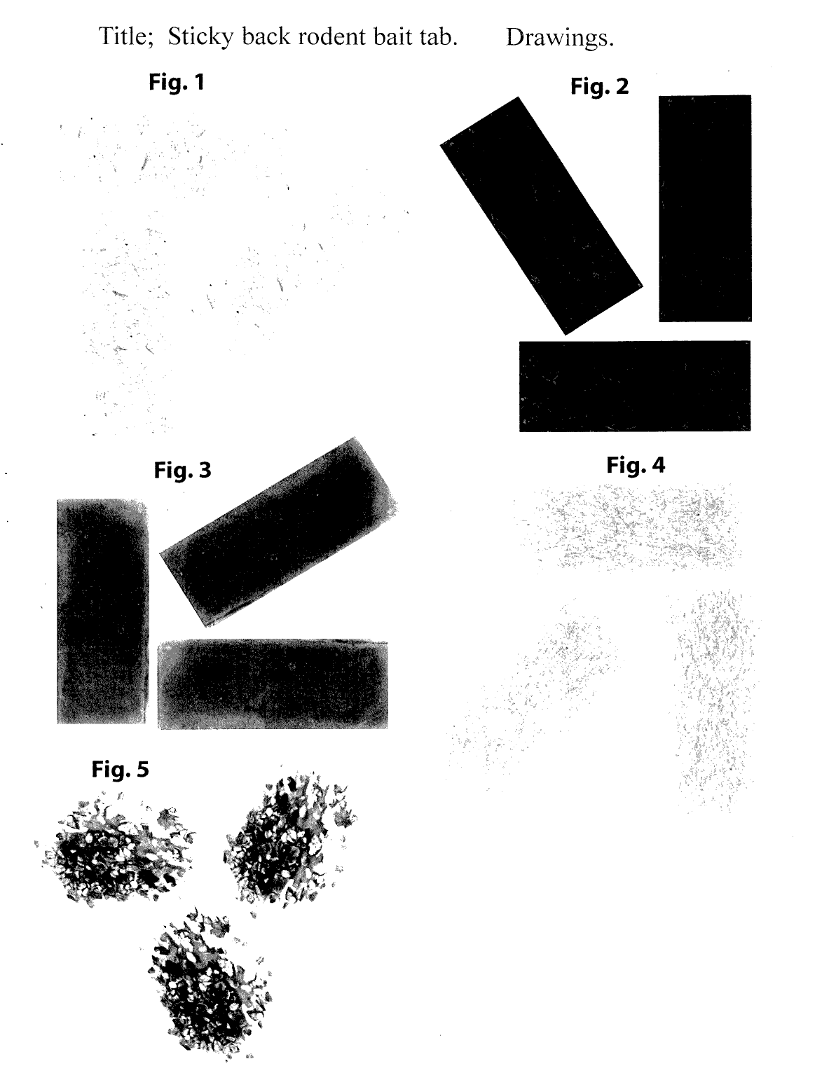

1; I claim thereby means for sticky back rodent bait tab Predetermined to affix to multitudes of different mouse Rat snap and or live traps.

2; Whereby sticky back rodent bait tab has distinctively Aroma to attract to tab.

3; Respectively all shapes and sizes to be predetermined Square, rectangle round and oval.

4; I claim that I believe is the only sticky back rodent bait tab.
